(19) United States
(12) Patent Application Publication
(10) Pub. No.: US 2015/0212847 A1
(43) Pub. Date: Jul. 30, 2015

(54) APPARATUS AND METHOD FOR MANAGING CACHE OF VIRTUAL MACHINE IMAGE FILE

(71) Applicant: Electronics and Telecommunications Research Institute, Daejeon (KR)

(72) Inventor: Song Woo SOK, Daejeon (KR)

(73) Assignee: Electronics and Telecommunications Research Institute, Daejeon (KR)

(21) Appl. No.: 14/606,616

(22) Filed: Jan. 27, 2015

(30) Foreign Application Priority Data
Jan. 28, 2014 (KR) 10-2014-0010600

(51) Int. Cl. G06F 9/455; G06F 12/08

(52) U.S. Cl. CPC G06F 9/45558; G06F 12/0848; G06F 2212/282; G06F 2009/4557

(57) ABSTRACT

Provided are an apparatus and method for managing a cache of a server memory executing a plurality of virtual machines. The apparatus for managing a cache of a virtual machine image file includes a cache layer configuring unit configured to divide a cache memory into cache blocks and configure a plurality of cache layers including the divided cache blocks, and a read request processing unit configured to manage the cache layers on the basis of information of a time interval between read requests and the number of referencing files according to a read request received by the cache memory, and transmit data of a corresponding cache block according to the read request.

### CROSS-REFERENCE TO RELATED APPLICATIONS

This application claims priority under 35 U.S.C. §119 to Korean Patent Application No. 10-2014-0010600, filed on Jan. 28, 2014, the disclosure of which is incorporated herein by reference in its entirety.

### TECHNICAL FIELD

The present invention relates to an apparatus and method for managing a cache of a server memory executing a plurality of virtual machines.

### BACKGROUND

In a virtualization technique of executing a plurality of virtual machines in a single server, data including operating systems of virtual machines is stored in a disk image file or a virtual machine image file allocated to a virtual machine, and when the virtual machine is booted, a corresponding virtual machine image file is opened to read or write data required for starting an operating system.

Generally, in most cases, virtual machines executed in a server providing a virtualization technology replicate a virtual machine image file of the same operating system and provide the same to a plurality of virtual machines.

Inputting and outputting the virtual machine image file largely take place intensively when virtual machines are booted and an application program is executed, and this is the same as a phenomenon in which inputting and outputting a disk takes place intensively when a PC is booted and an application program is executed.

FIG. 1 is a view illustrating an architecture of a cloud computing system providing a virtual desktop infrastructure (VDI) according to a related art. As illustrated in FIG. 1, a VDI service, among cloud computing services, is a service executing virtual machines providing a virtualized desktop environment in a server and providing a screen and an interface to a user.

In the VDI service environment, booting of a plurality of virtual machines take place intensively at a particular time slot such as a time immediately after an attendance time of staff members (or employees) who use the VDI service, input/output load of virtual machine image files explodes.

This phenomenon drastically degrades inputting and outputting performance of virtual machine image files of the entire virtual machines, which is called boot storm or a boot storm phenomenon.

In order to solve the boot storm phenomenon, a technique of sequentially booting virtual machines in advance before a user uses the virtual machines has been proposed an example of a related art.

The related art technique prevents a bottleneck phenomenon in inputting and outputting disk images when booting is simultaneously performed and allows a user to use own desktop computer immediately when logging in. However, server resource is wasted as unnecessary virtual machines are executed, since which of virtual machines the user will use cannot be known. And if there is no regularity in virtual machines usage pattern, such a related art is difficult to apply.

A general cloud computing system providing a VDI service as illustrated in FIG. 1 has an architecture of storing user virtual machine image files 30a to 30z in a shared storage 30 connected to a network, and accessing data of the virtual machine image files.

Such architecture has high flexibility in disposing the virtual machines 10a, 10n, 20x, and 20z and servers 10 and 20, thus enhancing efficiency of utilization of service resource and having an advantage in terms of error durability and maintenance.

However, in the architecture as illustrated in FIG. 1, since overall inputting and outputting of image files of virtual machines should be performed through the network, a bottleneck phenomenon occurs in the network connecting the servers 10, 20 and the shared storage 30 when boot storm takes place.

By storing all or part of the virtual machine image files in a local repository (a memory or a local disk) existing in a server, an input/output load amount of virtual machines through the network may be reduced and the bottleneck phenomenon may be mitigated.

Patent Document (Korean Laid Open Publication No. 1999-0082741 entitled “Method and Apparatus for Hibernation in Distributed Data Processing System”) discloses a technique of improving booting performance of a network computer (NC). As means to this end, it discloses a technique of hibernating information required for booting on a local disk of the NC, when each NC connected to a network is booted. It uses data stored in a remote server in the distributed data processing system connected to a network.

Patent Document (Korean Laid Open Patent Application No. 1999-0082741 may be applied as a technique for improving booting performance of virtual machine even in a VDI service cloud system utilizing the shared storage connected to the network.

The technique of storing boot image on local disks of a server may improve booting performance of the virtual machines and reducing the bottleneck phenomenon of the network, but having a problem in that a considerable amount of local disk resource should be used and mobility of the virtual machines between servers is degraded.

Another prior art document (US Laid Open Publication No. US20110265083 A1 entitled “File System Independent Content Aware Cache”) proposes a technique of optimizing the use of cache as a technique of managing a cache for virtual machines. It discloses duplication removal of data having same contents in a cache by using a content aware filter. But it does not disclose a cache replacement algorithm.

### SUMMARY

Accordingly, the present invention provides an apparatus and method for managing a cache of a virtual machine image file by storing data largely used for booting virtual machines, among data of virtual machine image files, in a memory of a server and managing a cache memory, thus improving booting performance.

In one general aspect, an apparatus for managing a cache of a virtual machine image file includes: a cache layer configuring unit configured to divide a cache memory into cache blocks and configure a plurality of cache layers including the divided cache blocks; and a read request processing unit configured to manage the cache layers on the basis of information of a time interval between read requests and the number of referencing files according to a read request received by the cache memory, and transmit data of a corresponding cache block according to the read request.

In another general aspect, a method for managing a cache of a virtual machine image file includes: dividing a cache memory into cache blocks and configuring a cache layer structure with the divided cache blocks; searching whether a cache block including identical file and offset information exists according to a read request received by the cache memory; managing the cache layer structure on the basis of information of time interval between read requests and the number of referencing files according to the result of searching whether a cache block having identical file and offset information; and delivering cache memory data in response to the read request.

Other features and aspects will be apparent from the following detailed description, the drawings, and the claims.

### BRIEF DESCRIPTION OF THE DRAWINGS

FIG. 1 is a view illustrating a cloud computing architecture providing a virtual desktop infrastructure (VDI) according to the related art.

FIG. 2 is a block diagram illustrating an apparatus for managing a cache of a virtual machine image file according to an embodiment of the present invention.

FIG. 3 through 5 are conceptual views illustrating a layout of a cache memory according to an embodiment of the present invention.

FIG. 6 is a conceptual view illustrating cache management by duplication removal according to an embodiment of the present invention.

FIG. 7 is a conceptual view illustrating multi-layer cache management structure according to an embodiment of the present invention.

FIG. 8 is a flow chart illustrating a process of initializing a cache memory according to an embodiment of the present invention.

FIG. 9 through 12 are flow charts illustrating processes of processing a read request according to an embodiment of the present invention.

FIG. 13 is a flow chart illustrating a process of processing a write request according to an embodiment of the present invention.

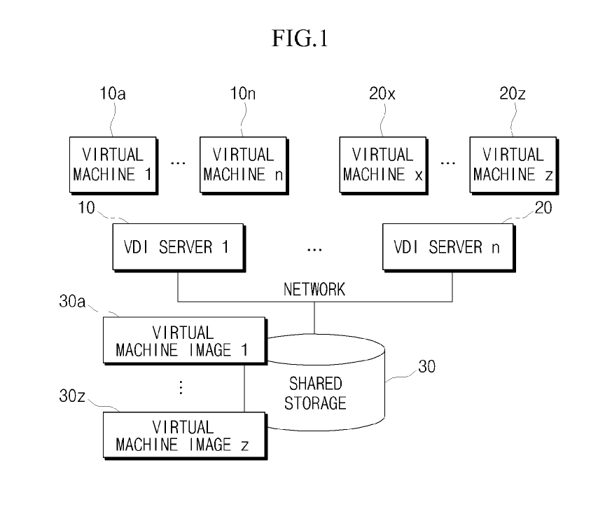

### DETAILED DESCRIPTION OF EMBODIMENTS

Hereinafter, embodiments of the present invention will be described in detail with reference to the accompanying drawings.

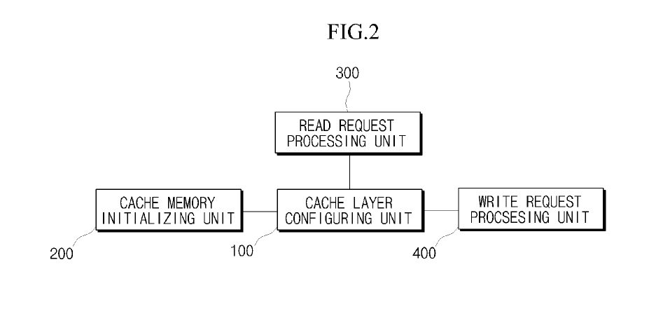

FIG. 2 is a block diagram illustrating an apparatus for managing a cache of a virtual machine image file according to an embodiment of the present invention.

As illustrated in FIG. 2, an apparatus for managing a cache of a virtual machine image file includes a cache layer configuring unit 100 and a read request processing unit 300.

The cache layer configuring unit 100 divides a cache memory into cache blocks and configures a plurality of cache layers including the divided cache blocks.

The read request processing unit 300 manages cache layers on the basis of information of a time interval between read requests and the number of referencing files according to a read request received by the cache memory and transmits data of a cache block corresponding to the read request.

The cache layer configuring unit 100 uses part of a local memory (RAM, SSD, hard disk, etc.) of a server employing a virtualization technology, as a cache memory.

The cache memory stores input/output data among data of the virtual machine image files, when booting is performed and an application is executed.

The cache layer configuring unit 100 divides the cache memory to form cache blocks, and manages the cache blocks in the form of linked list.

The cache memory used by the apparatus for managing a cache of a virtual machine image file according to an aspect of the present invention aims at preventing performance degradation caused by boot storm, and thus, the cache memory stores data for read request only and assigns higher priority to data having a shorter time interval between read requests.

When a virtual machine is booted, number of read requests overwhelms that of write requests, and thus, it is important to reduce an input/output load of read requests for improving booting performance, and here, processing only read requests may lead to implementation of a simpler structure and achievement of higher performance due to a reduction in load, without the necessity of considering data consistency.

When the virtual machine is booted or an application program is executed, read requests are intensively made at very short time intervals. When this situation takes place in various virtual machines, a bottleneck phenomenon occurs in an input/output network to degrade performance.

In order to prevent the occurrence of such a bottleneck phenomenon, in the present invention, data having a shorter time interval between read requests is preferentially stored in the cache memory, thereby increasing a cache hit rate in the situation in which input/output requests are intensively made at short time intervals.

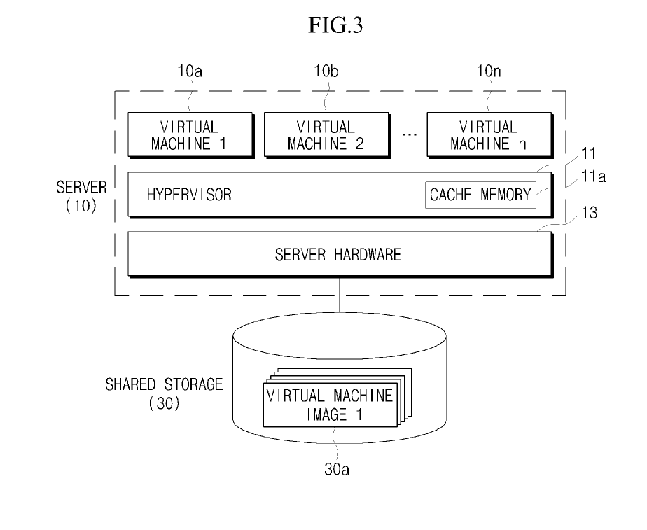

FIG. 3 through 5 are conceptual views illustrating a layout of a cache memory according to an embodiment of the present invention.

The cache layer configuring unit 100 divides a cache memory present in a hypervisor of a sever, present in a particular virtual machine of the server, or present between an operating system and the hypervisor of the server into cache blocks.

FIG. 3 is a view illustrating a type in which a hypervisor 11 providing virtualization is present above an actual hardware 13, and virtual machines 10a, 10b, . . . 10n are generated above the hypervisor 11, and the hypervisor 11 processes input/output through the actual hardware 13.

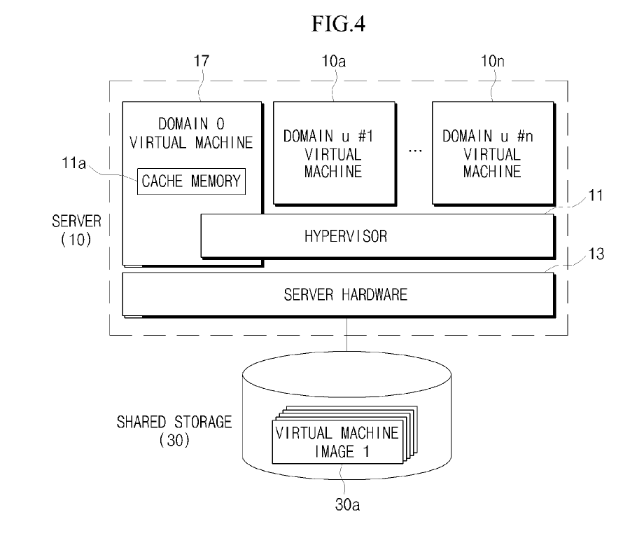

FIG. 4 is a view illustrating a virtualization technology according to a Xen scheme. Among virtual machines, a particular virtual machine 17 (domain 0 virtual machine) manages device and processes input/output, rather than the hypervisor 11. A cache memory 11a is positioned in the particular virtual machine 17.

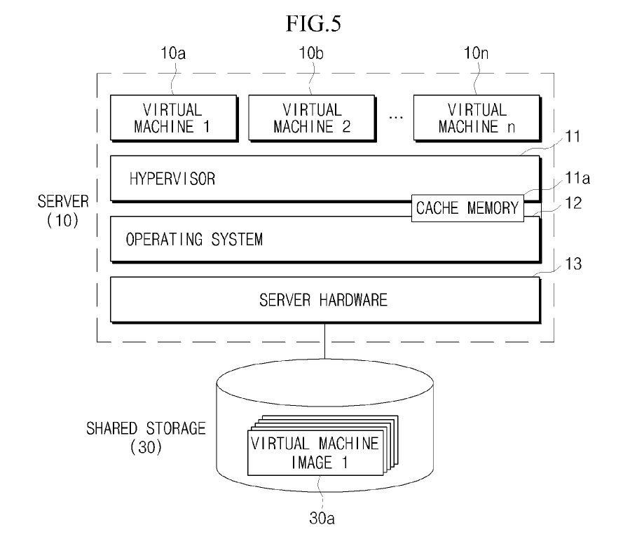

In FIG. 5, a general operating system (OS) 12 is present above the server hardware 13, and the hypervisor 11 is present above the general OS 12. The virtual machines 10a, 10b, . . . , 10n are generated above the hypervisor 11, and the cache memory 11a is positioned between the OS 12 and the hypervisor 11.

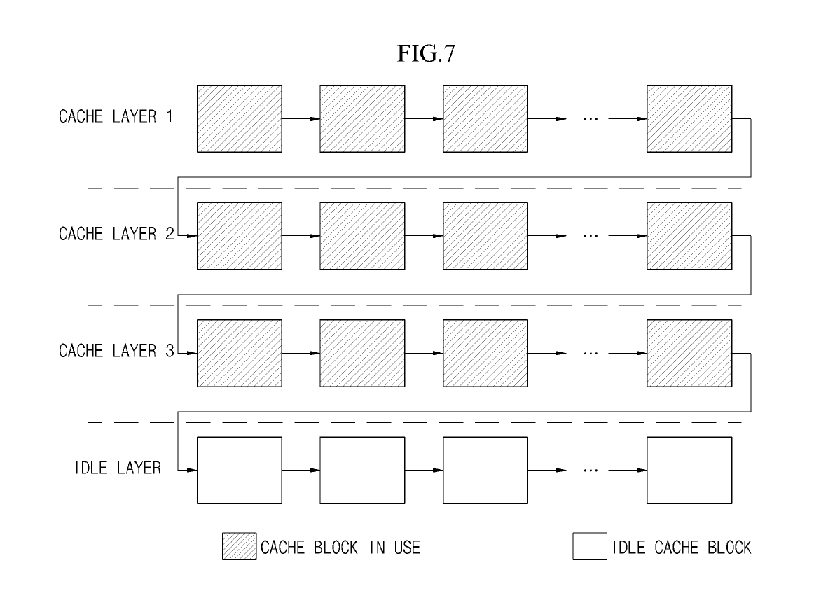

FIG. 7 is a conceptual view illustrating multi-layer cache management structure according to an embodiment of the present invention. In configuring a plurality of cache layers, the cache layer configuring unit 100 divides a cache memory into units having a predetermined size (e.g., 4 kb) and manages the units, and here, the divided units are called cache blocks.

The cache blocks are managed in a linked list and belong to one of four cache layers including a cache layer 1, a cache layer 2, a cache layer 3, and an idle layer 4.

To help a person skilled in the art understand the present invention, a total of four cache layers are illustrated in FIG. 7, and the number of cache layers may be adjusted according to a setting, and the present invention is not limited to the structure of the cache layers illustrated in FIG. 7.

A final cache block of the cache layer 1 is connected to a first cache block of the cache layer 2. A final cache block of the cache layer 2 is connected to a first cache block of the cache layer 3. And a final cache block of the cache layer 3 is connected to a first cache block of the idle layer.

The cache layer 1 stores data having a short time interval between read requests and referred to by a plurality of files.

The cache layer 2 stores data having a short time interval between read requests and referred to by a small number of files.

The cache layer 3 stores data having a long time interval between read requests.

When a read request for a cache block is generated, the cache layer configuring unit 100 selects a cache layer considering time intervals between read requests with respect to data of the corresponding cache block and the number of referencing files. Then, the cache layer configuring unit 100 inserts the corresponding cache block into the forefront of the corresponding cache layer.

Also, when a request for reading a certain cache block is not generated for long periods of time, the corresponding block may be gradually left behind and put even on the back of the final block of the cache layer 3.

When a new cache block is required, the cache layer configuring unit 100 may allocate a cache block in the idle layer. If there is no cache block in the idle layer, the cache layer configuring unit 100 deallocates the final cache block of the cache layer 3, and use it by switching to an idle block.

Thus, data of the cache layer 1 has a higher probability of remaining in the cache, relative to data of the cache layer 2, and data of the cache layer 2 has a higher probability of remaining in the cache, relative to data of the cache layer 3. As data has shorter time interval between read requests and is shared by a larger number of files, the survival probability of data increases. Therefore, in present invention, it enhances cache hit rate of requested data in the event of exploding input/output loads such as boot storm.

The cache layer configuring unit 100 manages virtual machine image file management information, cache management information, and cache block management information (cache block meta data) in order to manage the cache layers.

The cache layer configuring unit 100 manages a file path, a recent read request time and a meta data address of a cache block in which recent read data is stored, as virtual machine image file management information.

The cache layer configuring unit 100 manages information of the cache layers 1 and 2 (meta data addresses of the first block and the final block, a maximum number of allowable blocks, the number of extra blocks), information of the cache layer 3 and the idle layer (meta data addresses of the first block and the final block, the number of current blocks), a threshold value of a time interval between read requests, a threshold value of a connected file number, a size of a cache block₇ and the number of cache blocks, as cache management information.

The cache layer configuring unit 100 manages a file referred to by a cache block and an sequence of position information within the file.

The cache layer configuring unit 100 manages a file path, an offset value within the file, a state flag, the number of files referred to by the cache block, a cache block address, a result value of cache block data hash, an average of time interval between read requests, the number of read request, and a meta data address of a front cache block in a linked list, as cache block management information.

The read request processing unit 300 inspects whether there is a cache block having identical file and offset information according to a read request.

When a cache block having identical file and offset information exists, the read request processing unit 300 updates information of an average of time interval between read requests of the corresponding cache block.

Here, if the updated average of time interval between read requests of the corresponding cache block is greater than a preset threshold value, the read request processing unit 300 inserts the corresponding cache block ahead of the leading block of a cache layer 3(cache layer 3 stores data having a long time interval between read requests).

Whereas, if the updated average of time interval between read requests of the corresponding cache block is smaller than the preset threshold value, the read request processing unit 300 compares the number of files referred to by the corresponding cache block and a preset file number threshold value.

Here, if the number of files referred to by the corresponding cache block is greater than the preset file number threshold value, the read request processing unit 300 stores data having a short time interval between read requests and referred to by a plurality of files, in the uppermost cache layer 1 (as mentioned above, cache layer 1 stores data having a long time interval between read requests).

But if there is no extra block in the uppermost cache layer 1, the read request processing unit 300 reconfigures the cache layer 2 and inserts the corresponding cache block ahead of the leading block of the uppermost cache layer 1.

If the number of files referred to by the corresponding cache block is smaller than the preset file number threshold value, the read request processing unit 300 stores data in a cache layer 2(as mentioned above, cache layer 2 stores data having a short time interval between read requests and referred to by a small number of files).

But if there is no extra block in the higher cache layer 2, the read request processing unit 300 reconfigures the cache layer 3 and inserts the corresponding cache block into a portion ahead of the leading block of the cache layer 2.

If there is no corresponding cache block having identical file and offset informatio, the read request processing unit 300 inspects whether a cache block exists in the idle layer.

When a cache block exists in the idle layer, the read request processing unit 300 retrieves the final cache block among cache blocks of the idle layer. Whereas, when a cache block does not exist in the idle layer, the read request processing unit 300 retrieves the final cache block of the lowermost cache layer (cache layer 3). The read request processing unit 300 records the file and offset information in the cache block retrieved from the idle layer or the lowermost cache layer (cache layer 3).

Here, the read request processing unit 300 reads data of the corresponding file into the cache block in which the file and offset information has been recorded.

The read request processing unit 300 calculates a hash value of the read data, stores it on cache block management information.

The read request processing unit 300 inspects whether a cache block exists which has the same hash value as the calculated and stored hash value.

When the cache block exists, the read request processing unit 300 adds the file and offset information to the cache block having the same hash value.

For duplication removal, the read request processing unit 300 deallocates the cache block in which the file and offset information has been recorded, and inserts the same into the idle layer.

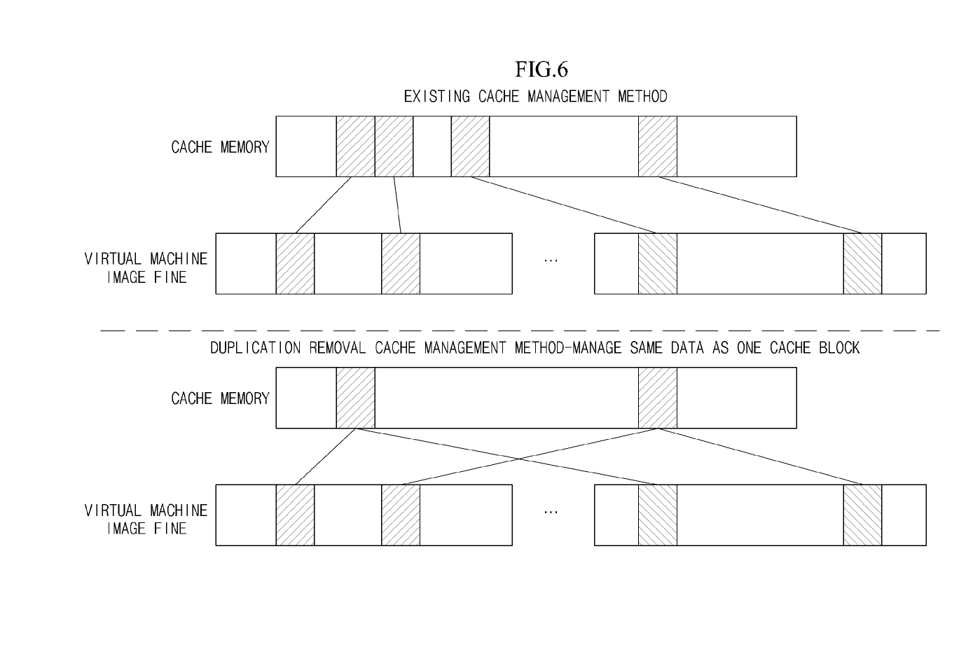

FIG. 6 is a conceptual view illustrating the duplication removal cache management as described above. According to the present invention, even though data items are read from different virtual machine image files, if contents of the data items are identical, duplication is removed by using a single cache block.

The apparatus for managing a cache of a virtual machine image file according to the present invention further includes a cache memory initializing unit 200.

The cache memory initializing unit 200 is executed according to execution of the hypervisor 11, and initializes cache block management information.

The apparatus for managing a cache of a virtual machine image file according to the present invention further includes a write request processing unit 400.

The write request processing unit 400 searches for a cache block having identical file and offset information according to a write request received by the cache memory. It removes file and offset information from a cache block if the cache block has identical file and offset information, and removes a file referred to by the cache block. Then, it deallocates the cache block and inserts it into the idle layer, and executes write operation on a file.

A method for managing a cache of a virtual machine image file according to another aspect of the present invention includes (a) dividing a cache memory into cache blocks and configuring a cache layer structure with respect to the divided cache blocks, (b) searching whether there is a cache block having identical file and offset information according to a read request signal received by the cache memory, (c) managing a cache layer structure on the basis of information of a time interval between read requests and the number of reference files according to the search result as to whether there is a cache block having identical file and offset information, and (d) delivering cache memory data in response to read request.

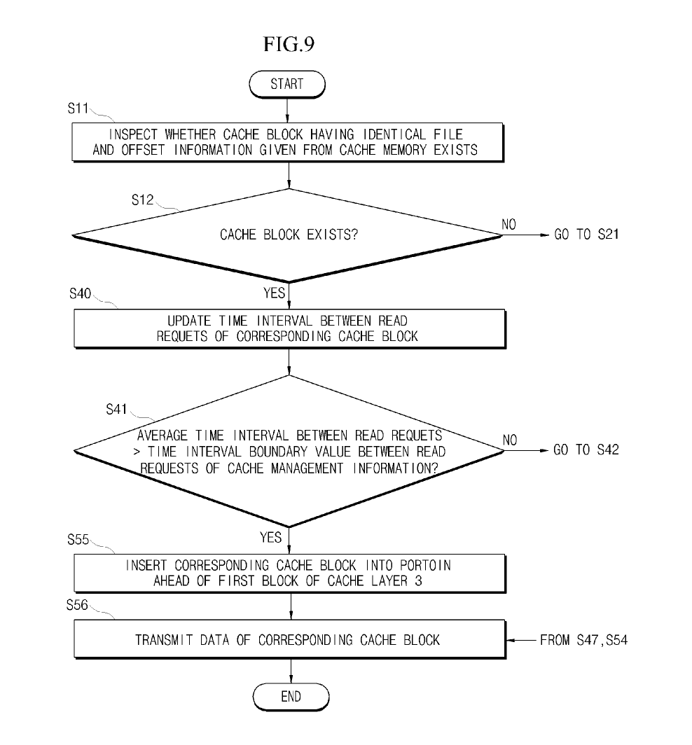

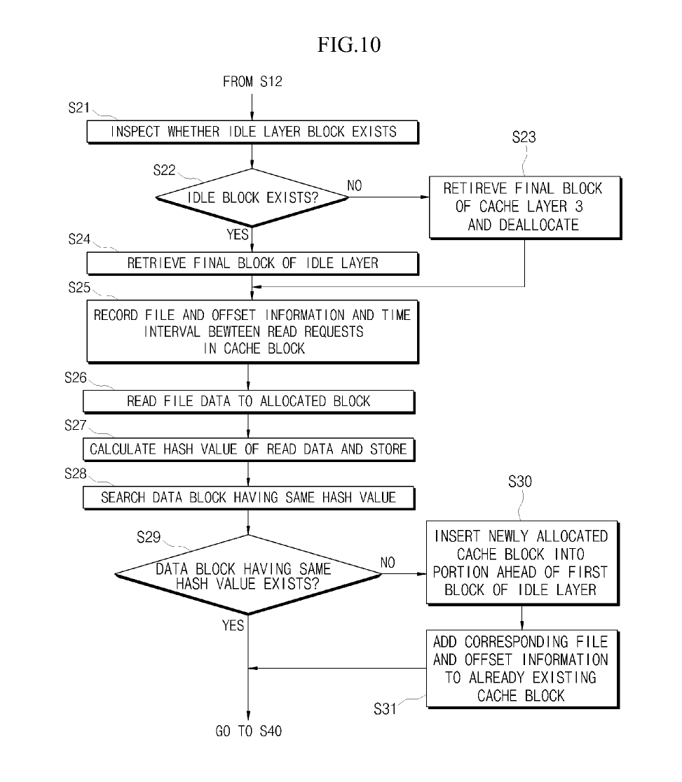

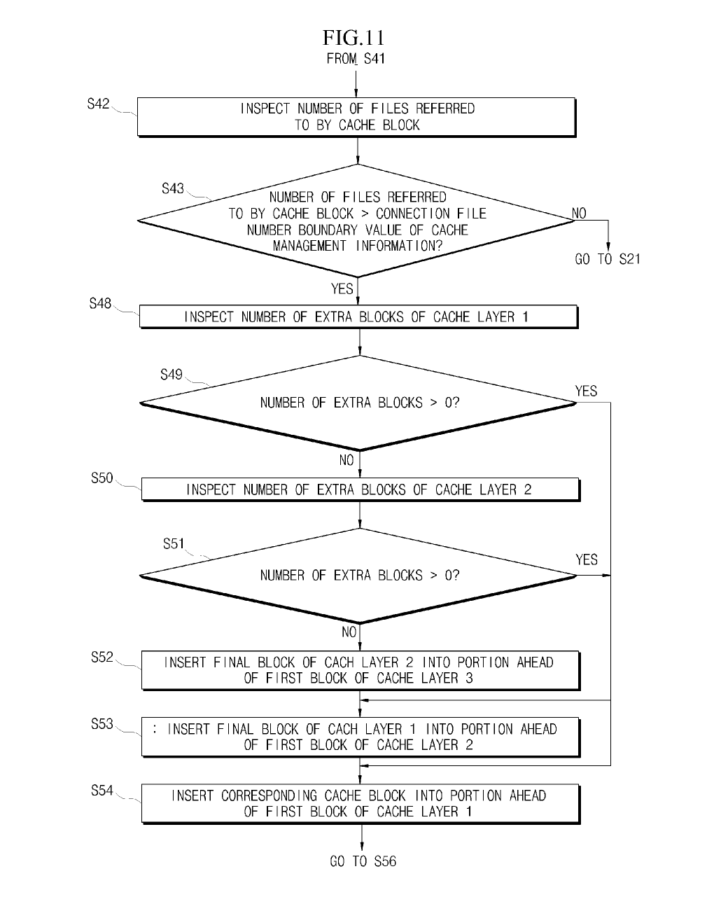

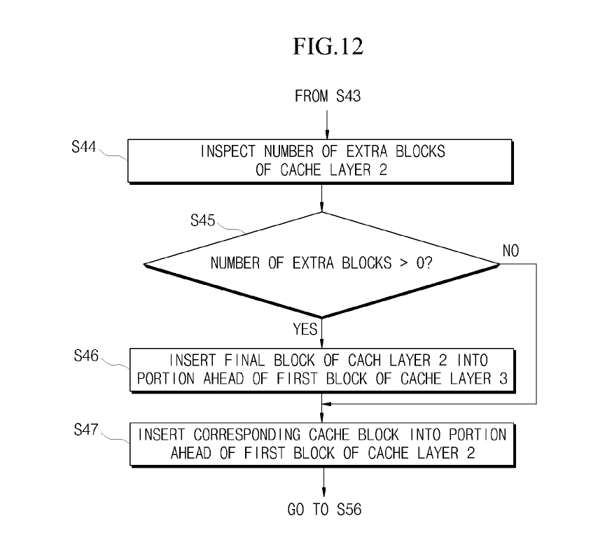

FIG. 9 through 12 are flow charts illustrating processes of processing a read request according to an embodiment of the present invention.

As illustrated in FIG. 9 through 12, it is inspected whether there is a cache block having identical file and offset information in step S11, and it is inspected whether a corresponding cache block exists in step S12.

If a cache block exists which has identical file and offset information, information of an average of time interval between read request of the corresponding cache block having identical file and offset information is updated in step S40.

The updated average of time interval between read requests of the corresponding cache block is compared with a preset threshold value in step S41.

If the updated average time interval between read requests of the corresponding cache block is grater than the preset threshold value, the corresponding cache block is inserted into the lowermost cache layer structure (cache layer 3) among the cache layer structures, excluding the idle layer 4, in step S55.

Whereas, if the updated average of time interval between read requests of the corresponding cache block is smaller than the preset threshold value, the number of files referred to by the corresponding cache block is inspected in step S42.

The number of files referred to by the corresponding cache block is compared with a preset file number threshold value in step S43.

According to the result of comparing in step S43, the corresponding cache block is inserted into the cache layer 1(uppermost layer among the cache layers) or ahead of the leading cache block of cache layer 2(lower layer of the uppermost layer).

Here, when the number of files referred to by the corresponding cache block is greater than the preset file number threshold value, the number of extra blocks of the uppermost cache layer (cache layer 1) is inspected in step S48.

When extra blocks exist as result of inspection in step S48, the corresponding cache block is inserted ahead of a first block of the uppermost cache layer (cache layer 1) in step S54.

Whereas, if the uppermost cache layer (cache layer 1) does not have an extra block, the final cache block of a cache layer 2(lower layer of the uppermost cache layer) is inserted into a portion ahead of a first block of the cache layer 3 in step S52.

After step S52, the final cache block of the uppermost cache layer (cache layer 1) is inserted ahead of a first block of cache layer 2 in step S53. Then, the corresponding cache block is inserted into a portion ahead of a first block of the uppermost cache layer (cache layer 1) in step S54.

If the number of files referred to by the corresponding cache block is smaller than the preset file number threshold value, the number of extra blocks of the cache layer 2 is inspected in step S44.

When an extra block exists in the cache layer 2, the corresponding block is inserted into a portion ahead of a first block of the cache layer 2 in step S47.

When there is no extra block in the cache layer 2, the final cache block of the cache layer 2 is inserted ahead of a first block of the lower layer (cache layer 3) in step S46 and the corresponding cache block is inserted ahead of a first block of the cache layer 2 in step S47.

When there is no cache block which has identical file and offset information, it is inspected whether there is a cache block in the idle layer among the cache layers in step S21.

When a cache block exists in the idle layer, the final cache block among the cache blocks of the idle layer is retrieved in step S24. When a cache block does not exist in the idle layer, the final cache block of the lowermost cache layer (cache layer 3) among the cache layers is retrieved in step S23. File and offset information are recorded in the retrieved cache block in step S25.

Here, file data of the file and offset information is read to the cache block in step S26, a hash value of the read file data is calculated and stored in step S27.

A cache block having a hash value identical to the calculated and stored hash value is searched in step S28.

When a cache block exists which has a hash value identical to the calculated and stored hash value, for duplication removal, the file and offset information of the cache block in which the file and offset information has been recorded are added to the cache block having the same hash value in step S31.

Then, the cache block in which the file and offset information has been recorded is deallocated, and the deallocated cache block is inserted into the idle layer to delete a duplicated cache in step S30.

The method for managing a cache of a virtual machine image file further includes a cache memory initialization step executed according to execution of the hypervisor and initializing the cache management information and cache block management information.

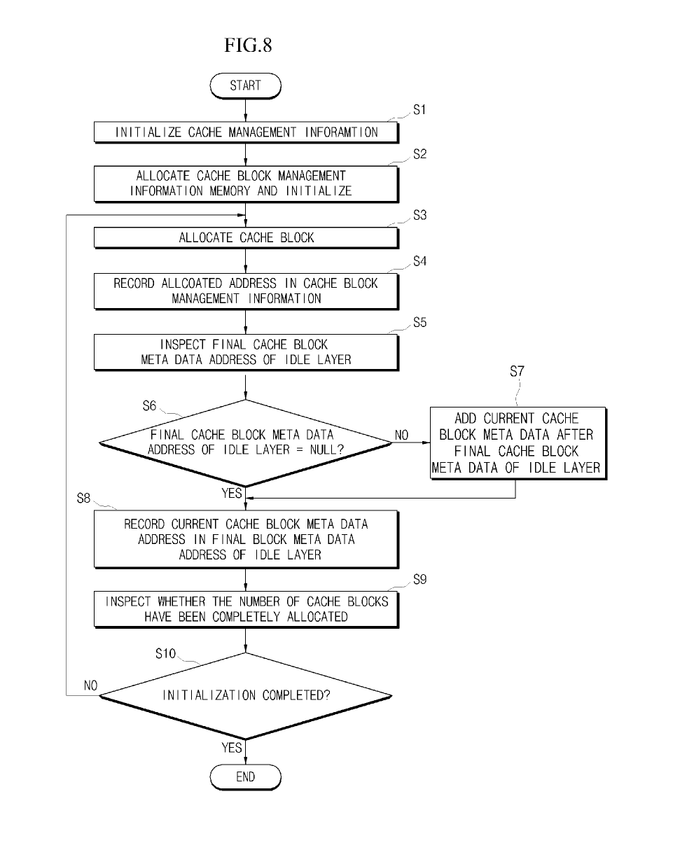

FIG. 8 is a flow chart illustrating a cache memory initialization process according to the present invention.

The cache memory initialization process includes a step (S1) of initializing cache management information, a step (S2) of allocating cache block management information memory and performing initialization, a step (S3) of allocating a cache block.

Further, The cache memory initialization process includes a step (S4) of recording an allocated address in cache block management information, a step (S5) of inspecting an address of final cache block meta data of the idle layer, a step (S7) of recording an address of the corresponding meta data in cache block meta data before the current cache block when a meta data address of a final block of the idle layer is not NULL, a step (S8) of recording an address of a current cache block meta data in a final block meta data address of the idle layer when the meta data address of the final block of the idle layer is NULL, and a step (S9) of inspecting whether the number of cache blocks has been completely allocated.

In step (S1) of initializing cache management information, meta data address of the first block and the final block of the cache layer are changed to NULL.

In step (S1), the maximum numbers of allowable blocks of the uppermost cache layer (cache layer 1 in present invention) and the higher cache layer (cache layer 2 in present invention) are set to a preset maximum value.

In step (S1), the number of extra blocks is set to be identical to the maximum number of allowable blocks, and the number of current blocks of the lower cache layer (cache layer 3) and the idle layer are set to 0.

In step (S1), a threshold value of a time interval between read requests and a connected file number threshold value are set, and a cache block size and a cache block number are set to a preset value.

In step (S2), cache block management information is allocated as the number of cache blocks, a file referred to by the cache block and position information within the file are initialized to NULL.

In step (S2), the number of files referred to by the cache block is initialized to 0, a cache block address is initialized to NULL, a cache block data hash result value is initialized to 0.

In step (S2), an average of time interval between read requests is initialized to a maximum preset value, a read request number is initialized to 0, and address of cache block meta data is initialized to NULL.

In step (S3), a memory is allocated corresponding to a single cache block size,

In step (S4), an address of a memory allocated is recorded to the address of cache block of the cache block management information.

The method for managing a cache of a virtual machine image file according to the present invention further includes: when a write request is received, searching for a cache block having identical file and offset information and executing a write operation on a file.

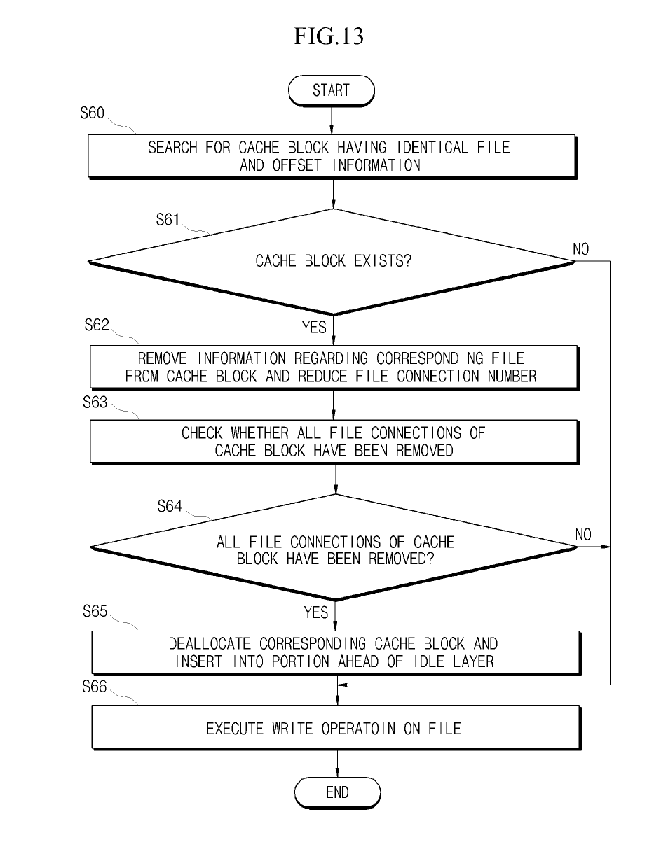

FIG. 13 is a flow chart illustrating a process of processing a write request according to an embodiment of the present invention. A cache block having identical file and offset information is searched in step S60.

When a cache block exists which has identical file and offset information, the corresponding file and offset information are removed from the cache block, and the number of referred files is reduced by 1 in step S62.

It is checked whether all of referred files have been removed in step S63.

When all of referred files have been removed, the corresponding cache block is deallocated and inserted ahead of the first block of the idle layer in step S65, and a write operation is executed on a file in step S66.

In the apparatus and method for managing a cache of a virtual machine image file according to the present invention, in a situation in which a server executing a plurality of virtual machines share virtual machine image files through a network, boot storm generated when the virtual machines are simultaneously booted and a particular application program is simultaneously executed is prevented, and input/output performance with respect to virtual machine image files can be improved.

Since duplication of data is removed and cache layers are managed by increasing priority of data commonly used between or among virtual machine image files, a bottleneck phenomenon of a network occurring due to an input/output load can be effectively improved although a small cache memory is used.

In addition, since data having a short time interval between read requests is preferentially stored in a cache memory, a cache hit rate can increase in a situation in which input/output requests are collectively, intensively made.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for managing a cache of a virtual machine image file, the apparatus comprising:
a cache layer configuring unit configured to divide a cache memory into cache blocks and configure a plurality of cache layers including the divided cache blocks; and
a read request processing unit configured to manage the cache layers considering information of a time interval between read requests and the number of referencing files according to a read request received by the cache memory, and transmit data of a corresponding cache block according to the read request signal.

2. The apparatus of claim 1, wherein the cache layer configuring unit uses a portion of a local memory of a server including a virtual machine, as a cache memory, and manages the cache blocks in a linked list form.

3. The apparatus of claim 2, wherein the cache layer configuring unit divides a cache memory existing in a hypervisor of the server, existing in a particular virtual machine of the server, or existing between an operating system and the hypervisor of the server, into the cache blocks.

4. The apparatus of claim 2, wherein the read request processing unit inspects whether a cache block having identical file and offset information exists according to the read request, and when a cache block having identical file and offset information exists, the read request processing unit updates information of an average of time interval between read request of the corresponding cache block.

5. The apparatus of claim 4, wherein when the updated average of time interval between read requests of the corresponding cache block is greater than a preset threshold value, the read request processing unit inserts the corresponding cache block into a portion ahead of the leading block of a cache layer storing data having a long time interval between read requests.

6. The apparatus of claim 4, wherein when the updated average time interval between read requests of the corresponding cache block is smaller than the preset threshold value, the read request processing unit compares the number of files referred to by the corresponding cache block and a preset file number threshold value, and when the number of files referred to by the corresponding cache block is greater than the preset file number threshold value, the read request processing unit stores the corresponding cache block in the uppermost cache layer having a short time interval between read requests and storing data referred to by a plurality of files, and when there is no extra block in the uppermost cache layer, the read request processing unit reconfigures the cache layers and inserts the corresponding cache block to a portion ahead of the leading block of the uppermost cache layer.

7. The apparatus of claim 6, wherein when the number of files referred to by the corresponding cache block is smaller than the file number threshold value, the read request processing unit stores the corresponding cache block in a higher cache layer having a short time interval between read requests and storing data referred to by a small number of files, and when an extra block does not exist in the higher cache layer, the read request processing unit reconfigures the cache layers and inserts the corresponding cache block into a portion ahead of a leading block of a higher cache layer.

8. The apparatus of claim 4, wherein when a cache block having identical file and offset information exists, the read request processing unit inspects whether a cache block exists in an idle layer among the cache layers, and when a cache block exists in the idle layer, the read request processing unit retrieves an end cache block among cache blocks of the idle layer, and when a cache block does not exist in the idle layer, the read request processing unit retrieves an end cache block of the lowermost cache layer among the cache layers, and records the file and offset information in the cache block retrieved from the idle layer or the lowermost cache layer.

9. The apparatus of claim 8, wherein the read request processing unit reads data of the corresponding file to the cache block in which the file and offset information have been recorded, calculates a hash value of the read data and records the calculated hash value in cache block management information, inspects whether a cache block having the same hash value as the calculated hash value exists, and when a cache block having the same hash value as the calculated hash value exists, the read request processing unit adds the file and offset information in the cache block having the same hash value, deallocates the cache block in which the file and offset information have been recorded, and inserts the same into the idle layer.

10. The apparatus of claim 3, further comprising:
A cache memory initializing unit configured to be executed according to execution of the hypervisor to initialize cache management information and cache block management information.

11. The apparatus of claim 1, further comprising:
a write request processing unit configured to search for a cache block having identical file and offset information according to a write request received by the cache memory, and configured to, when a cache block having identical file and offset information exists, remove the corresponding file and offset information from the cache block, remove a file referred to by the cache block, deallocate the cache block, insert the same into an idle layer, and execute a write operation on a file.

12. A method for managing a cache of a virtual machine image file, the method comprising:
dividing a cache memory into cache blocks and configuring a cache layer structure with the divided cache blocks;
searching whether a cache block including identical file and offset information exists according to a read request received by the cache memory;
managing the cache layer structure considering information of time interval between read requests and the number of referencing files according to the result of searching whether a cache block having identical file and offset information; and
delivering cache memory data in response to the read request.

13. The method of claim 12, wherein the managing of a cache layer structure comprises: when a cache block having identical file and offset information exists, updating information of an average of time interval between read requests of the corresponding cache block identical to the file and offset information, comparing the updated average of time interval between read requests of the corresponding cache block with a preset threshold value, and when the updated average of time interval between read requests of the corresponding block is greater than the preset threshold value, inserting the corresponding cache block into the lowermost cache layer structure excluding an idle layer in the cache layer structure.

14. The method of claim 13, wherein the managing of the cache layer structure comprises: when the updated average of time interval between read requests of the corresponding cache block is smaller than the preset threshold value, comparing the number of files referred to by the corresponding cache block with a preset file number threshold value, and inserting the corresponding cache block into a portion ahead of a leading cache block of the uppermost layer or a lower layer of the uppermost layer among the cache layers according to the result of comparison between the number of files referred to by the corresponding cache block and the preset file number threshold value.

15. The method of claim 12, wherein the managing of a cache layer structure comprises: when a cache block having identical file and offset information does not exist, inspecting whether a cache block exists in an idle layer among the cache layers, when a cache block exists in the idle layer, retrieving an end cache block among cache blocks of the idle layer, and when a cache block does not exist in the idle layer, retrieving an end cache block of the lowermost layer among the cache layers, and recording the file and offset information in the retrieved cache block.

16. The method of claim 15, wherein the managing of a cache layer structure comprises: reading file data of the file and offset information to the cache block, calculating a hash value of the read file data, and when a cache block having the same hash value as the calculated hash value exists, adding the file and offset information of the cache block in which the file and offset information have been recorded, to the cache block having the same hash value.

17. The method of claim 16, wherein the managing of a cache layer structure comprises: deallocating the cache block in which the file and offset information have been recorded, and inserting the deallocated cache block into the idle layer to delete a repeated cache.

18. The method of claim 12, further comprising: a cache memory initializing step of initializing cache management information and cache block management information, after being executed according to execution of a hypervisor.

19. The method of claim 12, further comprising: when a write request signal is received, searching for a cache block having identical file and offset information according to the received write request, and executing a write operation on a file.

20. The method of claim 19, wherein the searching of a cache block and executing a write operation on a file comprises: when a cache block having identical file and offset information exists, removing the corresponding file and offset information from the cache block, removing a file referred to by the cache block, and deallocating the cache block.
